(19) United States
(12) Patent Application Publication
(10) Pub. No.: US 2020/0247177 A1
(43) Pub. Date: Aug. 6, 2020

(54) VEHICLE WHEEL

(71) Applicant: THYSSENKRUPP CARBON COMPONENTS GMBH, Wilsdruff STT Kesselsdorf (DE)

(72) Inventors: Jens WERNER, Coswig (DE); Christian KÖHLER, Dresden (DE); Michael FRANKE, Dresden (DE); Florian FRANKE, Dresden (DE); Michael DRESSLER, Dresden (DE); Sandro MÄKE, Dresden (DE); André BARTSCH, Dresden (DE)

(73) Assignee: THYSSENKRUPP CARBON COMPONENTS GMBH, Wilsdruff STT Kesselsdorf (DE)

(21) Appl. No.: 16/755,944

(22) PCT Filed: Oct. 25, 2018
(86) PCT No.: PCT/DE2018/100873

§ 371 Date: Apr. 14, 2020

(30) Foreign Application Priority Data
Oct. 28, 2017 (DE) 10 2017 125 350.5

(51) Int. Cl. B60B 5/02

(52) U.S. Cl. CPC B60B 5/02; B60B 2900/513; B60B 2360/3416

(57) ABSTRACT

A vehicle wheel that is connectable to a brake system may include a wheel rim and a wheel disk. The wheel rim and/or the wheel disk may include a support structure comprised of fiber-reinforced plastic. The wheel rim and/or the wheel disk, at least on a side of the support structure that faces the brake system, may have a thermo-function structure that in thermal terms is configured so as to be more conductive than the support structure and is disposed so as to extend in such a manner that thermal energy generated by the brake system is discharged from a first region of the wheel rim and/or of the wheel disk that on account of said thermal energy is highly stressed in thermal terms into a second region of the wheel rim and/or of the wheel disk (3) that is less stressed in thermal terms.

The invention relates to a vehicle wheel which is able to be connected to a brake system and the wheel rim thereof and/or wheel disk thereof has a support structure from fiber-reinforced plastics material.

The invention relates to vehicle wheels in which the wheel rim and the wheel disk comprise in each case fiber-reinforced plastics material, or to so-called hybrid vehicle wheels in which one of the vehicle wheel components is composed of a different material such as, for example, light metal.

The wheel disk, proceeding from a wheel hub, can on the one hand be configured so as to be closed, disk-shaped, or open in a star-shaped manner having spokes, wherein the spokes terminate in a wheel flange of the wheel disk, or are connected directly to a wheel rim which comprises the wheel disk.

The vehicle wheel is able to be connected to a brake system by way of the wheel hub of the wheel disk.

Vehicle wheels are impinged with high thermal loads by the brake system of a motor vehicle in particular during the braking procedure, said high thermal loads being created as a consequence of the kinetic energy being converted to thermal energy. In the case of brake systems having disk brakes for example, operating temperatures of up to 1000° C. can arise herein.

The thermal loads are transmitted to the vehicle wheel mainly on account of convection and thermal radiation. Those regions of the wheel disk and of the wheel rim that are particularly close to the brake system, in particular to the brake disk, are exposed to particularly high thermal stresses herein.

While wheel disks or wheel rims from metal withstand those thermal stresses, wheel disks or wheel rims from fiber-reinforced plastics material, or having component parts from fiber-reinforced plastics material, as a consequence of said thermal loading, inter alia because of the low temperature resistance of the matrix material, reach their stress limits. The mechanical properties such as strength and rigidity thus are reduced as a result of the thermally caused softening of the resin system, which can lead inter alia to undesirable damage to the components.

A vehicle wheel from fiber-reinforced plastics material which for the thermal protection of the support structure from fiber-reinforced plastics material has a thermal protection structure is known from publication WO 2016/097159, said thermal support structure being composed of a combination of at least one heat-reflecting layer on the surface of the vehicle wheel, and of an (insulating) layer of low heat conductivity and/or a thermally conducting layer situated below said heat-reflecting layer.

The thermal protection structure is disposed in portions so as to be close to the surface on the support structure of the vehicle wheel, or is embedded in said support structure.

The heat-reflecting layer is composed of metal or a ceramic material. The (insulating) layer of low heat conductivity is composed of a fiber-reinforced plastics material or a ceramic material, or of a combination thereof. The thermally conducting layer is composed of a metal sheet, a metal mesh, or a metal woven fabric, or from a metal foil, respectively.

The thermal energy input is to be minimized on account of the heat-reflecting layer, on the one hand, wherein thermal insulation (thermal barrier) in relation to the support structure of fiber-reinforced plastics material is to take place by way of the (insulating) layer of low heat conductivity that is situated below said heat-reflecting layer.

A thermally conducting layer which is alternatively embedded between the heat-reflecting layer and the (insulating) layer of low heat conductivity is intended to distribute the thermal energy input across a comparatively large region of the insulating and reflecting layer of the thermal protection structure provided in portions.

The degree of thermal protection significantly depends on the quality of reflection, or the quality of insulation, respectively, of the respective thermal protection layers and thus depends on the material, the local disposal, and the wall thickness of said thermal protection layers. Consequently, increased masses, or masses which are non-uniformly distributed on the vehicle wheel, have to be taken into account.

There is additionally the risk that, as a consequence of the operation-related temperature variation cycles and dissimilar materials and thermal expansion coefficients of the thermal protection layers among one another and in relation to the support structure of the vehicle wheel from fiber-composite material, the layers can be released from the support structure.

In terms of thermal technology, a disadvantageous influence on the thermal emission capability of the thermal protection structure results on account of this embodiment in an external reflection layer in combination with an insulating and thermally conducting layer, since the proportion of the thermal load introduced into the external reflection layer on account of the reflective capability of the reflection layer is also reflected inward, wherein the reflection layer forms a thermal barrier in relation to the outside; the heat can thus not be discharged to a sufficient extent which is a further consequence of the thermal protection structure that is disposed in a locally delimited manner leading to unfavorable local heating of the vehicle wheel.

It is furthermore disadvantageous that inevitable contamination of the vehicle wheel and thus of the external heat-reflecting layer has the effect that the originally present degree of reflection, which is directed to the outside, significantly decreases on account of which the vehicle wheel absorbs increasingly more heat.

The invention is based on the object of widening and improving the application potential of the vehicle wheels of the type mentioned in motor vehicles, in particular to guarantee a permanent operational reliability of the vehicle wheels on account of a lower thermal loading.

The object is achieved according to the invention, on the one hand, in that the wheel rim and/or the wheel disk, at least on a side of the support structure that faces the brake system, has a thermo-function structure which in thermal terms is configured so as to be more conductive than the support structure and is disposed so as to extend in such a manner that a thermal energy generated by the brake system is substantially discharged from a region of the wheel rim and/or of the wheel disk that on account of said thermal energy is highly stressed in thermal terms into at least one region of the wheel rim and/or of the wheel disk that is less stressed in thermal terms.

The thermo-function structure which in thermal terms is more conductive in comparison to the support structure is applied to the surface of the support structure and is configured in a targeted manner so as to extend far across the surface of the support structure of the wheel rim and/or of the wheel disk.

The invention has the purpose of protecting the support structure of the wheel rim, or of the wheel disk, respectively, which is composed of fiber-composite material and is situated below the thermo-function structure, or is obscured by the thermo-function structure, respectively, from undesirable, locally excessive thermal loading, the latter being created by the thermal energy generated in the brake system in particular during the braking procedure and in the subsequent stationary phase of the motor vehicle. The brake disk, for example, is one of the particularly heated parts in the brake system.

The thermal energy generated by the brake system, by means of reciprocating with the thermo-function structure that extends in a planar manner, is discharged from the region of the wheel rim, or of the wheel disk, respectively, (local thermal input region) that is thermally highly stressed on account of said thermal energy, in at least one region, preferably a plurality of regions, of the wheel rim, or of the wheel disk, respectively, (thermal output region(s)) that is/are in thermal terms less stressed by the brake system.

On account of the higher thermal conductivity of the thermo-function structure in comparison to the support structure, the thermal energy is directed predominantly and in a targeted manner along the extent of the thermo-function structure.

The invention is moreover based on the concept that, for example in an active braking phase of the motor vehicle, in particular during enduring, rapidly alternating acceleration and braking maneuvers, there is permanent and very high thermal loading, substantially by way of thermal radiation, mainly on the wheel disk and in a region of the wheel disk (hotspot region-wheel disk) which is closely spaced apart from intensely heated parts of the brake system, such as the brake disk; whereas the regions of the wheel disk that are spaced farther apart from the intensely heated parts of the brake system and faces away from the latter, as well as the wheel rim with the rim well, with the support of the airflows caused by the moving vehicle, are in this operating phase thermally less loaded in comparison to the hotspot region of the wheel disk.

In contrast, the major thermal loading, substantially on account of thermal radiation and on account of convection, in the stationary phase of the motor vehicle is in a region of the rim well of the wheel rim, in particular in the drop center of the rim well (hotspot region-rim well), that is closely spaced apart from the intensely heated parts of the brake system; whereas the regions of the wheel rim that are spaced farther apart from the intensely heated parts of the brake system and faces away from the latter, as well as the wheel disk, in this operating phase by virtue of the vertical air flow along the vehicle wheel generated in the stationary phase, as a result of the thermal convection that arises are thermally less stressed in comparison to the hotspot region of the rim well.

These dissimilar thermal effects of the vehicle operating phases on the vehicle wheel can be observed in particular in the case of a wheel disk which is configured as a wheel center having spokes, but also relevant in the case of other variants of the wheel disk such as, in the case of dish-shaped wheel disks with closed faces, for example.

The invention according to claim 1 exploits these thermal effects from the different vehicle operating phases, so as to, on account of the embodiment and extent of the thermo-function structure according to the invention, absorb the thermal energy from the brake system, which in the direct environment thereof generates a high ambient temperature and thermal radiation loading, locally across the respective hotspot region of the wheel rim, or the wheel disk, respectively, (local thermal input region of the thermo-function structure), to discharge in a very efficient manner by means of the high thermal conductivity of the thermo-function structure the thermal energy into the regions of the wheel rim, or of the wheel disk, respectively, which are in each case thermally less stressed, and to dissipate said thermal energy into an environment of the wheel rim, or of the wheel disk, respectively, which is tempered to a lesser extent (thermal output region(s) of the thermo-function structure). The function of the thermo-function structure herein can be directed in a reciprocating manner, so as to correspond to the dissimilar local thermal energy input caused in the various vehicle operating phases.

It has been established that the support structure of the wheel rim, or of the wheel disk, respectively, which lies below the thermo-function structure, or is obscured by the thermo-function structure, respectively, is heated to a significantly lesser extent than is the case in embodiments according to the prior art, such that the thermal load of said support structure is minimized in the interest of protecting the material, this significantly improving the operational reliability of the vehicle parts (wheel rim, wheel disk).

Advantageous design embodiments and refinements of the invention are derived from the dependent patent claims, from the description hereunder, and from the associated drawings.

According to one advantageous embodiment, the thermo-function structure is configured so as to be highly thermally conductive.

The thermally highly conducting property of the thermo-function structure leads to an even more efficient heat discharge into the regions of the wheel rim, or of the wheel disk, that are less stressed in thermal terms, on account of which the necessary layer thickness of the thermo-function structure can be minimized in favor of the requirements in terms of mass set for the lightweight-construction the vehicle wheel, and the support structure of the wheel rim, or of the wheel disk, respectively, is simultaneously protected in an efficient manner against excessive thermal loading.

A thermo-function structure which is configured so as to be thermally highly conductive, has a thermal conductivity having a thermal conduction coefficient in the range from approximately 100 to 1100 W/mK.

Copper foils or braided copper structures are suitable as materials or material composites for the thermally highly conductive thermo-function structure, for example.

According to one particularly advantageous embodiment, the thermo-function structure is configured so as to be radiation-absorbing and radiation-emitting in the infrared wave range.

By means of the particular radiation absorption capability of the thermo-function structure, the thermal energy from the brake system can be absorbed directly as thermal radiation directly in the respective hotspot region of the wheel rim, or the wheel disk, respectively, (local thermal input region of the thermo-function structure), and by means of the thermal conductivity of the thermo-function structure, said thermal energy, directed in a reciprocating manner so as to correspond to the operating states, dissipated into the regions of the wheel rim, or the wheel disk, respectively, that are in each case less stressed in thermal terms, and by means of the radiation emission capability of the thermo-function structure emitted into the environment of the wheel rim, or of the wheel disk, respectively, that is tempered to a lesser extent (thermal output region(s) of the thermo-function structure).

The thermo-function structure of the wheel rim, or of the wheel disk, respectively, in a universal manner thus assumes a plurality of thermal functions.

The invention herein further proceeds from the fact that the radiation generated by the brake system is mainly present as thermal radiation in the long-wave, invisible, infrared wave range. A thermal radiation in the infrared wave range is characterized by a wavelength of approx. 780 nm to 100 μm.

A material of the thermo-function structure which is radiation-absorbing and radiation-emitting in particular in the infrared wave range can therefore particularly well absorb and re-emit the thermal radiation acting on the wheel disk, or on the wheel rim, respectively.

In particular in a combination of the advantageous absorbing and emitting properties in the infrared wave range with the advantageous thermal conduction properties of the universal thermo-function structure, the thermal energy can be efficiently absorbed within the thermo-function structure, be dissipated in the longitudinal extent of the thermo-function structure, and be distributed and re-emitted in regions that are less stressed in thermal terms.

The support structure of the wheel rim, or of the wheel disk, respectively, that lies below the thermo-function structure, or is obscured by the thermo-function structure, respectively, is even less heated on account thereof such that the thermal loading of said support structure can be lowered even further.

Moreover, the effective mode of the thermo-function structure is barely influenced on account of external influences from the environment, such as the contamination of the surface of the vehicle wheel, for example, since the thermal conduction properties of the thermo-function structure are in principle not dependent on the degree of contamination of the surface, and the absorbing and emitting properties of the thermo-function structure which function in the infrared wave range can be varied only to a very minor extent, if at all, by a contamination of the surface.

For example, anodized aluminum sheet, or a braided anodized aluminum structure, or an aluminum foil with a black coating, are suitable as materials or material composites for the universal thermo-function structure, said materials or material composites combining the advantageous properties of thermal conductivity and radiation absorption and radiation emission in the infrared wave range.

The additional highly thermal-conducting property of the thermo-function structure enhances the aforedescribed advantages by way of an even more efficient heat dissipation into the regions of the wheel rim, or of the wheel disk, respectively, that are less stressed in thermal terms, so as to protect the support structure of the wheel rim, or of the wheel disk, respectively, from excessive thermal loading at the same time providing a minor layer thickness of the thermo-function structure.

A black magnesium coating, or a braided rubber-silver structure can be applied as materials or material composites that are suitable according to the invention for the universal thermo-function structure, for example, the latter, apart from the claimed absorption/emission properties, moreover being highly thermally conductive.

It is particularly advantageous for the thermo-function structure to contain carbon fibers.

The carbon fibers, depending on the fiber type, have good thermal conductivity, (for example carbon fibers based on PAN (polyacrylonitrile)), or very good to high thermal conductivity (for example high-modulus carbon fibers, pitch-based carbon fibers), on the one hand.

Highly thermally conducting carbon fibers have a thermal conductivity such as, for instance, copper, or more than the latter; the thermal conductivity of said highly thermally conducting carbon fibers is defined by a thermal conduction coefficient in a range from 140 to 1100 W/mK.

Moreover, on account of the use of carbon fibers as opposed to metal fibers, undesirable corrosion is avoided in the interaction with the support structure of the wheel rim and/or the wheel disk from fiber-reinforced plastics material.

The larger the proportion of carbon fibers in the thermo-function structure, the greater the effect of the advantages in terms of the protection of the support structure and thus in terms of the operational reliability of the vehicle wheel.

By virtue of their high tensile strength, rigidity, and low mass, carbon fibers are advantageously suitable as reinforcement fibers for facilitating the support function of the fiber-composite support structure of the wheel rim and/or the wheel disk, on the other hand.

The mass of the support structure of the wheel rim and/or the wheel disk required for the functional stability can consequently be reduced when carbon fibers are used in the thermo-function structure.

The functions of the thermo-function structure are very advantageously additionally widened to include a mechanical support function of the wheel rim and/or the wheel disk from fiber-composite material, this leading to a favorable minimization in terms of material.

According to one particularly advantageous design embodiment, the thermo-function structure is configured as a so-called real blackbody.

An ideal “blackbody”, also referred to as a “full radiator” according to the physical definition by way of a radiation absorption capability of 1 completely absorbs all impacting electromagnetic radiation, thus also light and thermal radiation. In turn, said blackbody re-emits the electromagnetic radiation completely as thermal radiation. The intensity and the spectral distribution of the thermal radiation are a function only of the temperature of the blackbody and the ambient temperature of the latter.

A radiation absorption capability of 1 cannot be achieved in practice, part of the impacting electromagnetic radiation is always reflected. In the case of bodies of this type, a practically achievable radiation absorption capability is almost 1, said bodies being referred to as “real blackbodies”.

The invention according to this embodiment exploits the properties of the real blackbody. The thermal radiation directly impacting the thermo-function structure is almost completely absorbed by the latter, effectively distributed and dissipated into regions that are less stressed in thermal terms, and as a result of the higher temperature difference in said regions, emitted as thermal radiation predominantly in the direction of the environment.

The support structure of the wheel rim, or of the wheel disk, respectively, which lies below the thermo-function structure, or is obscured by the thermo-function structure, respectively, as a result of the particularly effective thermal radiation absorption of the thermo-function structure in regions that are highly stressed in thermal terms, and of the likewise effective radiation emission of the thermal radiation in regions that are less stressed in thermal terms, is heated only to a minor extent so that thermal loads in the support structure of the wheel rim, or of the wheel disk, respectively, that damage the material are reliably avoided. Insulating measures on the support structure can therefore be dispensed with in principle.

Anodized metal sheet, gold fibers embedded in black silicone, or silver foil painted black, are suitable as the material, or a material composite, respectively, for a thermo-function structure which is configured as a real blackbody, for example.

According to one preferred design embodiment of the invention, the thermo-function structure contains pitch-based carbon fibers.

Said carbon fibers are preferably composed of long-chain carbon atoms having carbon network planes along the fiber axis and are harvested based on bituminous residuals (pitch) from the distillation of tar. The pitch is melted by way of a particular hydration treatment, spun, and carbonized, on account of which the particular orientation and drafting of the carbon networking is achieved.

The pitch-based carbon fibers combine all aforementioned advantageous properties and advantages of the thermo-function structure. Said carbon fibers are highly thermally conducting, apart from adequate strength said fibers also have a high rigidity so as to serve in a material-minimizing manner as a support structure of the wheel rim, or of the wheel disk, respectively, and can function as real blackbodies.

The larger the proportion of the pitch-based carbon fibers in the thermo-function structure, the more favorable the advantageous effects of the aforementioned properties in terms of the protection of the support structure and thus in terms of a permanent operational reliability of the vehicle wheel.

Apart from the aforedescribed properties, the pitch-based carbon fibers also have a very good temperature resistance such that this is additionally conducive to a permanent operational reliability of the vehicle wheel.

While this is technically conceivable but economically not expedient, the fiber-reinforced plastics material of the wheel rim and/or of the wheel disk is produced completely based on pitch-based carbon fibers, the required support structure and the thermo-function structure of the wheel rim and/or of the wheel disk thus being combined in a mass-minimizing manner in a homogenous structure. In the case of this embodiment, explicit thermal protective measures for the support structure are dispensed with, such that no further materials and masses are required for a functionally conforming lightweight-construction vehicle wheel having at the same time a high operational reliability. However, the scope of pitch-based carbon fibers required in terms of quantity and the high economic complexity associated therewith are obstacles in terms of the practical application of this embodiment.

According to one advantageous embodiment, the thermo-function structure is formed from a fibrous woven fabric, a fibrous knitted fabric, or a fibrous scrim.

The thermally relevant materials, in the shape of fibers or tapes, such as, for example, the carbon fibers or metal fibers, can be interwoven or embedded in pure form, or in conjunction with other materials such as, for example, other plastics-material fibers, in the woven fabric, the knitted fabric, or the scrim, a uniform and/or partial distribution of the thermal properties in the thermo-function structure being hereby able to be implemented according to the individual requirements. The textile structure moreover enables a consciously oriented disposal of the thermally relevant fiber or tape materials. The distribution of thermal energy and the thermal dissipation can thus be directed in a targeted manner along the thermo-function structure.

The embodiment as a woven fabric, a knitted fabric, or a scrim moreover facilitates the exact placing, or shaping, respectively, of the thermo-function structure on the contour of the support structure of the wheel disk, or of the wheel rim, respectively, and thus improves the effective mode of the thermo-function structure.

If the fibrous woven fabric, the fibrous knitted fabric, or the fibrous scrim is configured so as to be elastic, the orientation and positioning of the thermally relevant materials can take place in an even more flexible manner when applying the thermo-function structure.

The elastic configuration of the fibrous woven fabric, the fibrous knitted fabric, or the fibrous scrim, respectively, in particular the use of elastic support threads, enables contour variations, for example in the case of draft angles or radial steps of the wheel rim, to be able to be compensated for when molding said elastic support threads, while maintaining the fiber orientation of the thermally conductive fibers of the thermo-function structure.

One particularly favorable design embodiment of the invention provides that a thermo-function structure of the wheel rim and a thermo-function structure of the wheel disk are connected to one another. The thermal energy, depending on the specific type of operation, can thus be distributed in a far-reaching manner from a surface of the wheel rim to a surface of the wheel disk, and vice versa.

According to a further favorable design embodiment, it is provided that the thermo-function structure of the wheel disk and/or of the wheel rim extends to or into a side of the wheel disk and/or of the wheel rim that faces away from the brake system.

The extent of the thermo-function structure in the case of the wheel rim, for example, can be to or into the external side of the rim flange.

The extent of the thermo-function structure in the case of the wheel disk, for example, can be to or onto the external side of the wheel flange, of the wheel plate, or of the spoke of the wheel disk, or of the wheel center, respectively.

To this extent, such regions of the wheel rim, or of the wheel disk, respectively, which in thermal terms are stressed to a minor extent, or not stressed, by the brake system can be efficiently utilized for discharging the thermal energy into the environment of the wheel rim, or of the wheel disk, respectively, that is tempered to a lesser extent.

It is also comprised by the invention that the respective thermo-function structures can completely cover the surface of the wheel rim and/or of the wheel disk, or can completely enclose a geometric contour of the wheel rim and/or of the wheel disk.

In particular when hybrid vehicle wheels are used, it can be advantageously provided that the thermo-function structure of the wheel disk and/or of the wheel rim is connected to a thermally conducting component of the vehicle wheel.

Thermally conducting components of the vehicle wheel can be, for example, a metallic wheel hub, a metallic wheel flange, individual metallic spokes, a local metal layer on the wheel rim or the wheel disk, or a completely metallic wheel rim or wheel disk.

On account of the connection to the thermo-function structure, the thermal energy transmitted by way of the thermo-function structure can be directed further to the thermally conducting component of the vehicle wheel, the latter on account of the geometric extent or mass, respectively, thereof being able to contribute toward a further efficient distribution of heat across the vehicle wheel.

For protecting the thermo-function structure in relation to environmental influences, and as an aesthetic design means for the vehicle wheel, it can be expediently provided that the thermo-function structure of the wheel rim and/or the thermo-function structure of the wheel disk have/has at least in portions a cover layer.

The cover layer assumes the function of thermal absorption and dissipates the heat to the thermo-function structure which in the region that is covered by the cover layer predominantly assumes a thermally conducting function.

The thermo-function structure in regions that are not covered by the cover layer can in turn be configured as a thermally conducting and thermally absorbing/emitting thermo-function structure, so as to locally amplify the distribution and discharge of heat.

The thermally absorbing cover layer is preferably composed of a heat-resistant material which can be, for example, a thermally resistant lacquer. Furthermore, a fiber-composite layer is also conceivable, the thermal loading thereof not having any relevance in terms of the load-bearing capability of the component (wheel rim/wheel disk).

For likewise purposes it can be provided that the thermo-function structure of the wheel rim and/or of the wheel disk at least in regions has an infrared-radiation-permeable cover layer.

This special infrared-radiation-permeable cover layer is particularly suitable in terms of the protection and the design of the universally configured thermo-function structure which is configured so as to be thermally conductive and additionally is configured so as to be radiation-absorbing and radiation-emitting in the infrared wave range. A PE film, which can be transparent or dyed so as to be opaque, is suitable as an expedient cover layer of this type, for example.

These features, and further features which are derived from the patent claims, the description, the exemplary embodiments and the drawings, can in each case be implemented individually or in combination as advantageous embodiments of the invention, protection therefore being claimed herein.

The vehicle wheel according to the invention will be explained in more detail hereunder by a plurality of exemplary embodiments. In the associated drawings, in each case in a schematic illustration:

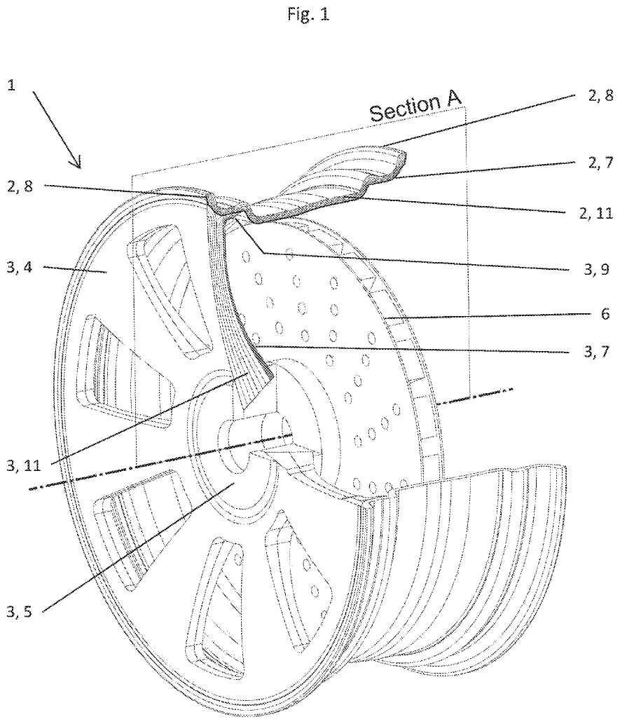

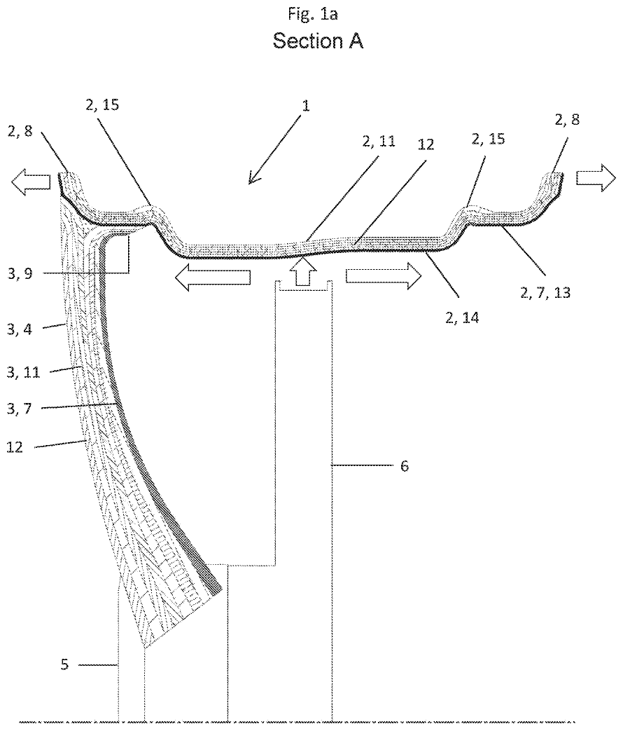

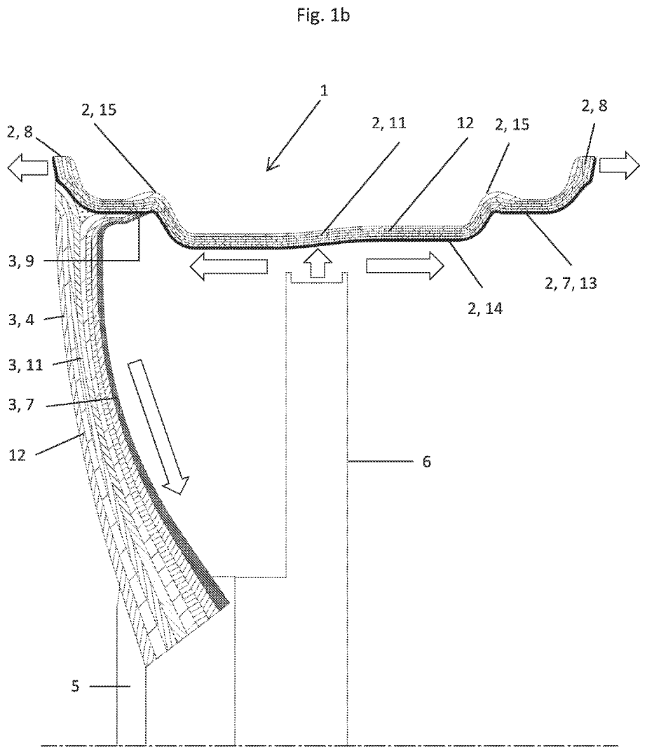

FIG. 1 shows an isometric illustration of a vehicle wheel having a wheel rim and a wheel center from fiber-reinforced plastics material and in each case one thermo-function structure on the wheel rim and the wheel center;

FIG. 1a shows a sectional view of the vehicle wheel according to FIG. 1, in a section plane A;

FIG. 1b shows a sectional view of a vehicle wheel, similar to that according to FIG. 1, in a section plane A, having a connected thermo-function structure on the wheel rim and the wheel center;

FIG. 1c shows a sectional view of a vehicle wheel, similar to that according to FIG. 1, in a section plane A, having a mutually transitioning thermo-function structure on the wheel rim and the wheel center;

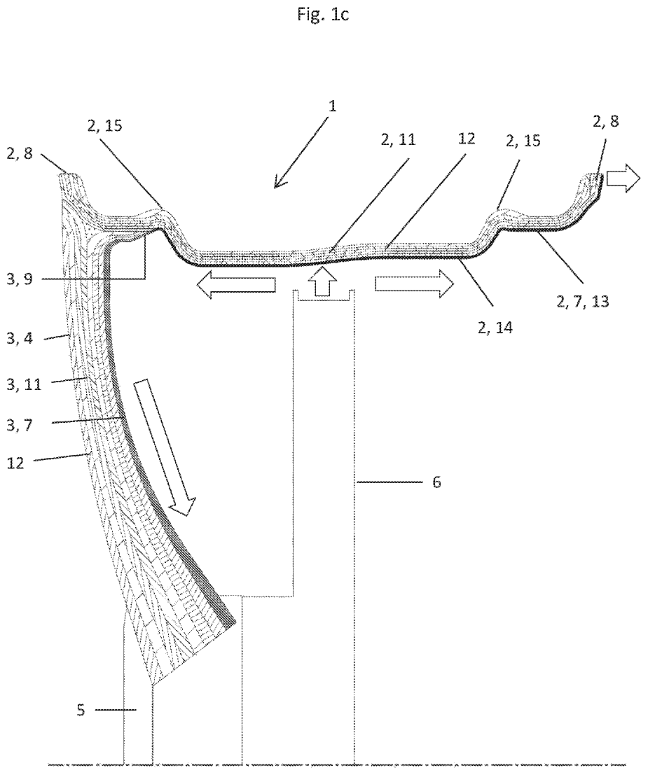

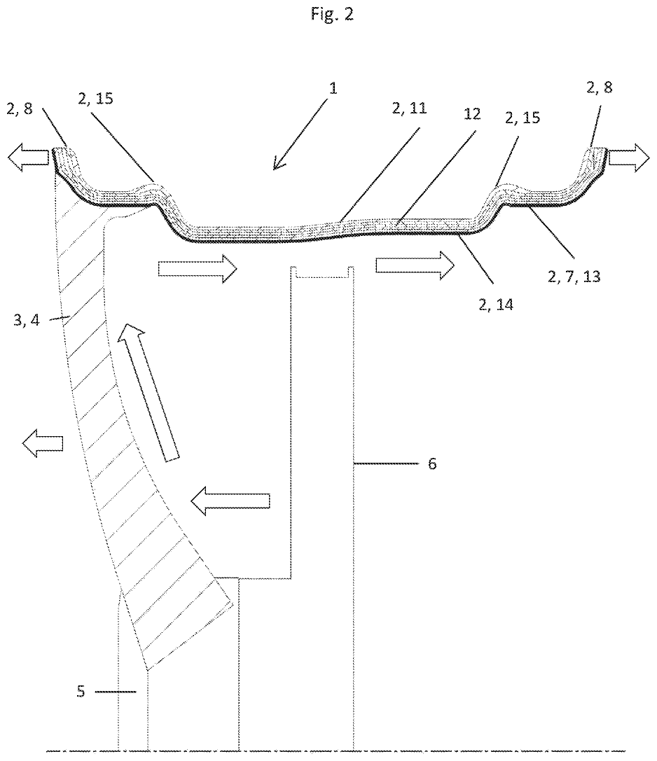

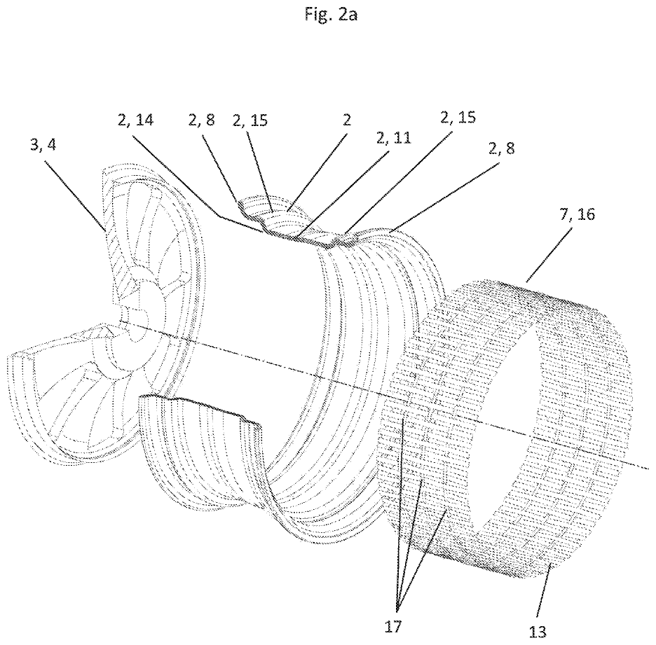

FIG. 2 shows a sectional view of a vehicle wheel, similar to that of FIG. 1, having an alternative wheel center;

FIG. 2a shows an exploded sectional illustration of a wheel rim of the vehicle wheel according to FIG. 2, having a thermo-function structure;

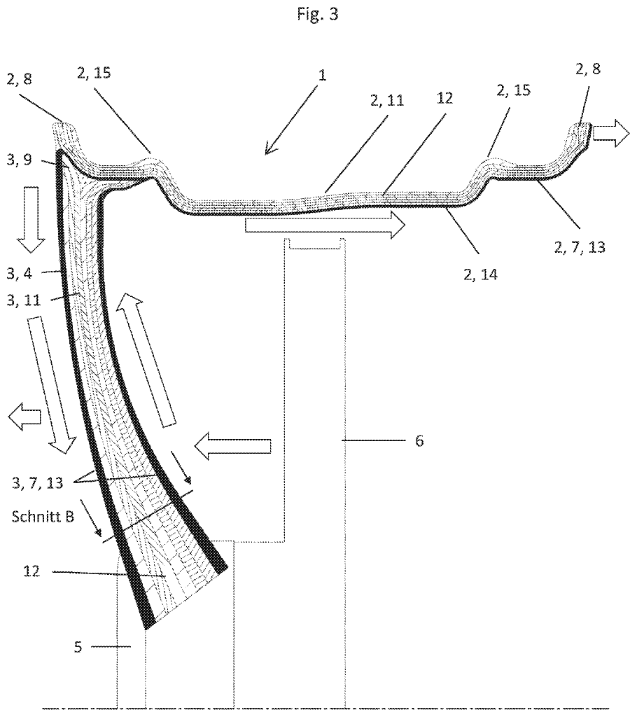

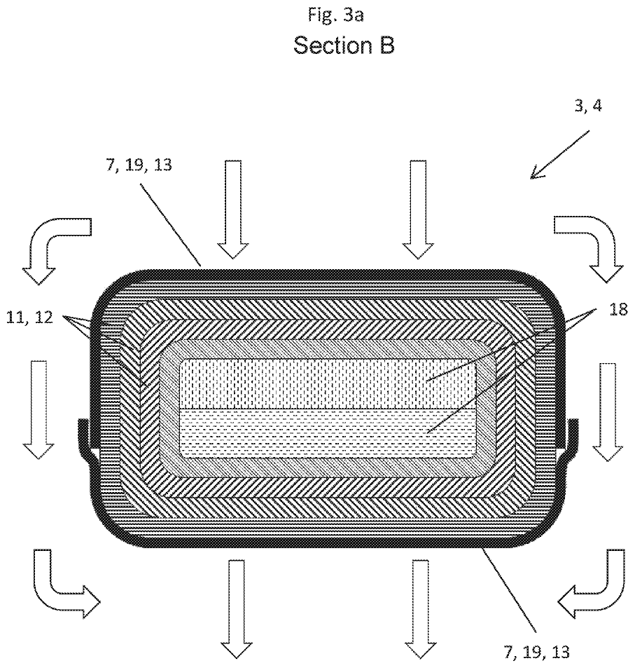

FIG. 3 shows a sectional view of a vehicle wheel, similar to that of FIG. 1, having a connected thermo-function structure on the wheel rim and about the entire wheel center;

FIG. 3a shows a sectional view of the vehicle wheel according to FIG. 3, through the spoke cross section;

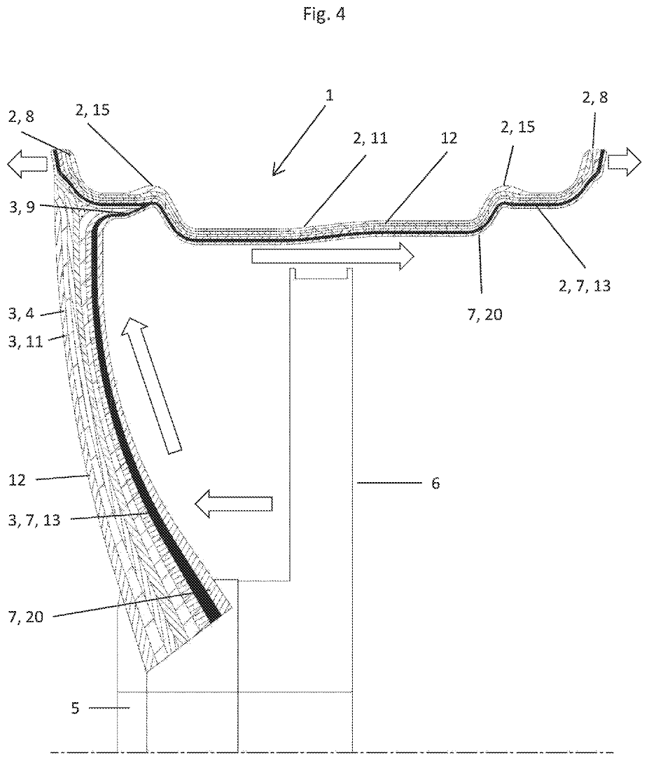

FIG. 4 shows a sectional view of a vehicle wheel, similar to that of FIG. 1, having a thermo-function structure and an infrared-radiation-permeable cover layer on the wheel rim and the wheel center.

FIG. 1 shows a vehicle wheel 1 according to the invention, having a wheel rim 2 and wheel disk 3 which is especially configured as a wheel center 3 having spokes 4. The wheel rim 2 and the wheel center 3 are in each case composed of carbon-fiber-reinforced plastics material. The vehicle 1, by way of the wheel hub 5 of the wheel center 3, can be connected to a brake system 6 which in the exemplary embodiment is schematically illustrated and has a brake disk 6.

The wheel rim 2 on a rim internal side that faces the brake disk 6, and the wheel center 3 at least on a wheel disk internal side that faces the brake disk 6, having each case one thermo-function structure 7 according to the invention. The thermo-function structure 7 of the wheel rim 2 extends across the entire rim internal side to the two rim flanges 8 of the wheel rim 2.

The thermo-function structure 7 of the wheel center 3 extends in the radial direction across the wheel center internal side to a wheel flange 9 of the wheel center 3 and can additionally protrude to or into the spoke intermediate spaces 10 of the wheel center 3, or completely fill said spoke intermediate spaces 10.

The thermo-function structures 7 of the wheel rim 2 and of the wheel center 3 cover in each case the rim-internal side surface of a support structure 11 of the wheel rim 2, or the surface of a support structure 11 of the wheel center 3 on the wheel-center-internal side and in the spoke intermediate spaces 10.

The wheel center 3 connected to the wheel rim 2, by way of the wheel flange 9 of the former, adjoins in a direct and planar manner the thermo-function structure 7 of the wheel rim 2.

FIG. 1a relates to a sectional view of the vehicle wheel 1 according to FIG. 1, along the section plane A, from which the details of the vehicle wheel 1 can be seen in more detail.

The support structure 11 of the wheel rim 2 and of the wheel center 3 have in each case a plurality of tiers 12 of the carbon-fiber-reinforced plastics material.

The thermo-function structure 7 of the wheel center 3 in this exemplary embodiment is composed of a thin anodized aluminum sheet which is thermally conductive as well as radiation absorbing and radiation emitting in the infrared wave range.

The anodized aluminum sheet covers the surface of the support structure 11 of the wheel center 3 in a planar manner on the wheel-center internal side, and is preferably screw-fitted or adhesively bonded.

The use of an anodized aluminum sheet as the thermo-function structure 7 enables a cost-effective and requirement-compliant selective and flexible assembly on the wheel center 3.

Alternatively, the thermo-function structure 7 of the wheel center 3 can be composed of a material woven fabric having anodized aluminum tapes and carbon fibers (not illustrated), wherein the carbon fibers in this case additionally contribute toward the thermal conductivity and toward the load-bearing property of the support structure 11 of the wheel center 3.

The thermo-function structure 7 of the wheel rim 2 in this exemplary embodiment is composed of a fibrous layer which contains pitch-based carbon fibers (pitch fibers) 13, or is composed of said fibrous layer. The fibrous layer can be configured as a braided fibrous woven fabric.

The thermo-function structure 7 of the wheel rim 2 by virtue of the pitch-based carbon fibers 13 is configured so as to be thermally highly conductive as well as in the form of a real blackbody which is particularly well radiation-absorbing and radiation-emitting in the infrared wave range.

The fibrous layer of the thermo-function structure 7, in addition to the thermal conduction function, thus assumes a support function for facilitating the support structure 11 of the wheel rim 2.

Individual fibrous layers, fibrous woven fabrics/fibrous knitted fabrics, or pre-formed segmented fibrous semi-finished products can be applied to the support structure 11 of the wheel rim 2, or to the support structure 11 of the wheel center 3, respectively, in order for the thermo-function structure 7 of the wheel rim 2 and/or of the wheel center 3 to be produced.

FIG. 1a shows the vehicle wheel 1 according to FIG. 1 in a stationary operating state immediately after a braking and travelling operation, hereunder referred to as the “stationary phase”.

The brake disk 6 which in the stationary phase is heated on account of a proceeding braking and travel operation of the vehicle wheel 1, generates an intensive thermal radiation (vertical arrow in FIG. 1a) which in a predominantly radially directed manner impacts the rim well, in particular the drop center 14, of the wheel rim 2 (hotspot of the wheel rim 2). The thermo-function structure 7 of the wheel rim 2 from pitch-based carbon fibers 13, as an almost real blackbody, absorbs said thermal radiation in a largely complete manner and directs the thermal energy from the hotspot of the wheel rim 2 along the thermo-function structure 7, both on the visible rim internal side as well as in the portion of the rim internal side that is obscured by the connection between the wheel rim 2 and the wheel center 3, in the direction of the two bead seats 15 and the two rim flanges 8 of the wheel rim 2 (horizontal arrows along the wheel rim 2 in FIG. 1a), said bead seats 15 and said two rim flanges 8 on account of the spacing thereof from the brake disk 6 being less stressed in thermal terms, and where the thermal energy is preferably emitted as thermal radiation to the atmospheric environment of the wheel rim 2 that in comparison to the hotspot of the wheel rim 2 and in comparison to the support structure 11 of the wheel rim 2 is tempered to a lesser extent (external horizontal arrows on the rim flanges 8 in FIG. 1a).

The thermal loading of the wheel rim 2 is locally minimized on account of the optimal distribution across the entire rim well, and thus protects the fiber-composite support structure 11 of the wheel rim 2 which is disposed below the thermo-function structure 7.

The wheel center 3 in this operating state of the vehicle wheel (stationary phase) by virtue of the thermal convection that arises in the vertical direction along the contour of the wheel center 3 is imparted less thermal radiation and thus no substantially high thermal stress.

In the operating state during the active braking and travelling operation of the vehicle wheel 1, which is hereunder referred to as the “braking phase” and is not shown in FIG. 1a, the thermal radiation created on account of the heated brake disk 6 is transmitted largely axially in the direction of the wheel center 3 and predominantly in a region of the wheel center 3 which is close to the wheel hub 5 and lies so as to be particularly close to the brake disk 6 (hotspot of the wheel center 3) to the thermo-function structure 7 of the wheel center 3, said thermo-function structure 7 being from anodized aluminum sheet. Only minor proportions of the thermal radiation are reflected by the surface of the anodized aluminum sheet. The majority of the thermal radiation in this hotspot region of the wheel center 3 is absorbed by the heat-absorbing thermo-function structure 7 of the wheel center 4, and is dissipated as thermal energy along the thermo-function structure 7 in the direction of the wheel flange 9 of the wheel center 3 and of the spoke intermediate spaces 10 (not visible here) which are further spaced apart from the brake disk 6 and in thermal terms are also facilitated on account of the impinging airflow in the travelling operation. There, the thermal energy, preferably as thermal radiation, is emitted by the thermo-function structure 7 of the wheel center 3 to the atmospheric environment of the wheel center 3 which in comparison to the hotspot of the wheel center 3 and the support structure 11 of the wheel center 3 is tempered to a lesser extent.

The wheel rim 2, in particular the rim well having the bead seats 15 and the rim flanges 8, as a result of the airflows arising on account of the travel, is in thermal terms only lightly stressed in this operating state.

FIG. 1b shows a sectional view of a vehicle wheel 1, similar to that according to FIG. 1, along the section plane A, said vehicle wheel 1 having slight deviations in comparison to the embodiment according to FIGS. 1, 1a.

In order to avoid repetitions, only the points of differentiation in terms of the features and effective modes in comparison to the embodiment of the vehicle wheel 1 according to FIGS. 1, 1a will be described hereunder.

The thermo-function structure 6 of the wheel center 3 according to this exemplary embodiment, as opposed to the embodiment according to FIG. 1a, is composed of a thin aluminum foil with a black coating, which is likewise both thermally conductive as well as radiation-absorbing and radiation-emitting in the infrared wave range.

The coated aluminum foil can be vapor-deposited, shrink-fitted, or adhesively bonded to the surface of the support structure 11 of the wheel center 3, or can be connected to the support structure 11 of the wheel center 3 in the curing process of the fiber-composite material. On account of the use of the coated aluminum foil as the thermo-function structure 11, the mass which does not contribute toward the load-bearing capability of the wheel center 3 can advantageously be reduced.

The thermo-function structure 7 of the wheel center 3 in the exemplary embodiment according to FIG. 1b, as opposed to the embodiment according to FIG. 1a, extends completely across the wheel center internal side up to and including the wheel flange 9 such that the thermo-function structures 7 of the wheel center 3 and of the wheel rim 2 are connected to one another in the transition region from the wheel center 3 to the wheel rim 2.

The operating state of the vehicle wheel 1 is likewise shown in the stationary phase in FIG. 1b. The procedures and effects correspond in principle to the descriptions in FIG. 1a, but the usable heat transmission paths and emission faces can be an enlarged on account of the additional connection between the thermo-function structures 7 of the wheel rim 2 and the wheel center 3 in the embodiment according to FIG. 1b.

The thermal radiation which is largely absorbed by the thermo-function structure 7 of the wheel rim 2 is directed as thermal energy along the thermo-function structure 7 of the wheel rim 2 by way of the visible rim internal side as also in the obscured portion of the rim internal side to the two rim flanges 8 (horizontal arrows along the wheel rim 2 and on the rim flanges 8 in FIG. 1b), on the one hand, and also directed and distributed along the thermo-function structure 7 of the wheel center 3 by way of the wheel center internal side (vertical arrow along the wheel center in FIG. 1b), where the thermal energy is in each case discharged into the environment that is tempered to a lesser extent.

As opposed to the description according to FIG. 1a, the thermal radiation created on account of the heated brake disk 6 in the operating state of the vehicle wheel 1 in the braking phase which is not shown in FIG. 1b, is largely transmitted to the thermo-function structure 7 of the wheel center 3 from aluminum foil with a black coating, which as an almost real blackbody can absorb the thermal radiation in a largely complete manner.

The absorbed thermal radiation is dissipated as thermal energy along the thermo-function structure 7 in the direction of the wheel flange 9 and of the spoke intermediate spaces 10 (not visible here), and distributed onward by way of the connected thermo-function structure 7 of the wheel rim 2, by way of the visible rim internal side of the rim well as well as by way of the obscured portion of the rim internal side, in the direction of the two bead seats 15 and of the two rim flanges 8 of the wheel rim 2, where the thermal energy is in each case discharged into the environment that is tempered to a lesser extent.

The embodiment enlarges the thermal transmission paths in favor of heat transportation which is across a larger area and more effective, in a reciprocating manner from the rim internal side of the rim well toward the wheel center internal side, and vice versa to the environment of the vehicle wheel that on account of the operation is in each case tempered to a lesser extent, this further minimizing the thermal loading of the vehicle wheel.

FIG. 1c shows a sectional view of a vehicle wheel 1, similar to that according to FIG. 1, along the section plane A, said vehicle wheel 1 having slight deviations in comparison to the embodiment according to FIG. 1b, wherein the operating state of the vehicle wheel 1 is likewise shown in the stationary phase.

In order to avoid repetitions, only the points of differentiation in terms of the features and effective modes in comparison to the embodiment of the vehicle wheel 1 according to FIG. 1b will be described hereunder.

The thermo-function structure 7 of the wheel rim 2 in the exemplary embodiment according to FIG. 1c, as opposed to the embodiment according to FIG. 1b, extends only across the visible rim internal side to the transition region from the wheel rim 2 to the wheel center 3, where said thermo-function structure 7 is connected to the thermo-function structure 7 of the wheel center 3 extending completely across the wheel center internal side such that the thermo-function structures 7 transition into one another.

The connection region between the wheel rim 2 and the wheel center 3 is thus excluded from the thermal transmission path of the thermo-function structure 7 of the wheel rim 2 such that said connection region can be imparted less thermal loading, and the operational reliability of thermally relevant connection constructions of the vehicle wheel can thus be improved.

Additionally derived are advantages in terms of production technology such as, for example, the possibility of retrofitting the thermo-function structures 7 to the internal side of an existing wheel, or to a wheel of integral or monolithic manufacture, respectively. Moreover, the application of the thermo-function structures 7 is possible in a manner independent of the production process of the vehicle wheel 1.

Here too, individual fibrous tiers, fibrous woven fabrics/fibrous knitted fabrics, or preformed, segmented fiber semi-finished products can be applied to the support structure 11 of the wheel rim 2 and of the wheel center 3 in order for the thermo-function structure to be produced.

FIG. 2 shows a sectional view of a vehicle wheel 1, similar to the vehicle wheel 1 according to FIGS. 1, 1a, 1b.

In order to avoid repetitions, only the points of differentiation in terms of the features and effective modes in comparison to the embodiment of the vehicle wheel 1 according to FIGS. 1, 1a, 1b will be described hereunder.

The vehicle wheel 1 according to FIG. 2 is a so-called hybrid vehicle wheel. As an alternative to the embodiment according to FIGS. 1, 1a, 1b, said hybrid vehicle wheel has a wheel center 3 from aluminum or from magnesium (optionally with an additional black coating), said wheel center 3 thus being thermally conductive to highly thermally conductive and being radiation-absorbing and radiation-emitting in the infrared wave range.

The wheel center 3 per se thus acts as a thermally conducting component (3) of the vehicle wheel, as well as the thermo-function structure which in the case of a wheel center from fiber composite material is provided for the thermal protection of the fiber-composite material.

The thermo-function structure 7 of the wheel rim 2, in a manner corresponding to FIG. 1, is composed of a fibrous layer having at least in part pitch-based carbon fibers (pitch fibers) 13, said fibrous layer being configured as a braided fibrous woven fabric 16 and, according to FIGS. 1, 1a, 1b extending across the entire rim internal side of the wheel rim 2.

The metallic wheel center 3 by way of the wheel flange thereof thus adjoins the thermo-function structure 7 of the wheel rim 2 in a direct and planar manner.

On account of this direct link between the thermo-function structure 7 of the wheel rim 2 and the metallic wheel center 3, the usable thermal transmission paths and the emission faces can be enlarged, in a manner analogous to the embodiment according to FIG. 1b.

The operating state of the vehicle wheel 1 in the braking phase is shown in FIG. 2, wherein the procedures and effects correspond in principle to the braking phase described in FIGS. 1a, 1b.

The heat radiation which is emitted axially in the direction of the wheel center 3 (horizontal arrow close to the wheel hub 5 in FIG. 2) herein is absorbed directly by the metallic wheel center 3, wherein (without a black coating) only a minor part of the thermal radiation is reflected and with a black coating almost the entire heat radiation is absorbed.

The absorbed thermal energy by way of thermal transmission can be distributed across the entire body of the wheel center 3 (arrow along the wheel center 3 in FIG. 2) and be emitted over a large area across the entire surface of the wheel center 3, in particular also across the spoke intermediate spaces and across the wheel center external side (horizontal arrow on the wheel center external side); said absorbed thermal energy by way of the connection to the thermo-function structure 7 of the wheel rim 2 can additionally be dissipated in the direction of the rim well and onward by way of the visible rim internal side and by way of the obscured portion of the rim internal side in the direction of the rim flanges 8 dissipated to the environment (horizontal arrows along the wheel rim 2 and on the rim flanges in FIG. 2).

Conversely, in the operating state of the stationary phase of the vehicle wheel 1 (not illustrated here), the thermal radiation absorbed largely by way of the thermo-function structure 7 of the wheel rim 2 in the hotspot region of the rim well cannot only be dissipated and emitted in the direction of the bead seats 15 and the rim flanges 8 but also be transmitted and distributed by way of the connected metallic wheel center 3 and there be discharged, or emitted, respectively, into the environment.

FIG. 2a shows an exploded sectional illustration of a wheel rim 2 of the vehicle wheel 1 according to FIG. 2, prior to the thermo-function structure 7 being applied to the support structure 11 of the wheel rim 2 on the rim internal side, and prior to the metallic wheel center 3 being assembled on the wheel rim 2.

The fibrous woven fabric 16 of the fibrous layer of the thermo-function structure 7 that contains the pitch fibers 13 here is configured in the form of a textile tube. The pitch fibers 13 which are oriented in the direction of the axle of the wheel rim 2, or of the vehicle wheel 1, respectively, are supported by fibers or threads 17 of the textile tube that run in the circumferential direction, and said pitch fibers 13 in terms of their orientation and positioning are largely fixed by said fibers or thread 17. When the thermo-function structure 7 is applied to the rim internal side of the wheel rim 2, a uniform positioning of the individual pitch fibers 13 running in parallel in the direction of the axle is thus guaranteed, this improving the distribution of thermal energy and the thermal dissipation along the thermo-function structure 7, in particular from the hotspot of the wheel rim 2 (drop center 14) in the direction of the two bead seats 15 and the rim flanges 8 of the wheel rim 2.

The support fibers or support threads 17 of the textile tube that run in the circumferential direction are configured so as to be elastic (for example from an elastomer), this facilitating the uniform and parallelized orientation and positioning of the pitch fibers 13.

The encircling elastic support threads 17 proved to be particularly advantageous for the configuration of a thermo-function structure 7 that is true to the contour in regions of the radial circumferential variation of the component geometry of the wheel rim 2.

In the production of the wheel rim 2 having the thermo-function structure 7, the elastic textile tube can thus first be fitted onto a mold that replicates the contour of the rim internal side of the wheel rim 2, and by means of corresponding cross-sectional expansions, or cross-sectional constrictions, respectively, of the elastic textile tube be molded precisely to the contour of the mold while retaining the desired fiber position and orientation of the pitch fibers 13, so as to configure the thermo-function structure 7 of the rim internal side of the wheel rim 2 to be true to the contour.

In order for the wheel rim 2 to be completed, the fibrous tiers of the support structure 11 of the wheel rim 2 in a subsequent braiding or winding procedure can be applied to the fibrous woven fabric 16 of the thermo-function structure 7 so as to be accurate in terms of the contour, and all fibrous tiers can subsequently be conjointly consolidated.

FIG. 3 shows a sectional view of a vehicle wheel 1, similar to the vehicle wheel 1 according to FIG. 1.

In order to avoid repetitions, only the points of differentiation in terms of the features and effective modes in comparison to the embodiment of the vehicle wheel 1 according to FIGS. 1, 1a will be described hereunder.

The wheel center 3 from carbon-fiber reinforced plastics material, as opposed to the embodiment according to FIGS. 1, 1a, has a thermo-function structure 7 from a fibrous layer comprising or being from pitch-based carbon fibers 13, said fibrous layer extending across the entire surface of the wheel center 3 and completely covering the latter.

This thermo-function structure 7, by virtue of the pitch-based carbon fibers, is thermally highly conductive as well as a real blackbody which is particularly well radiation-absorbing and radiation-emitting in the infrared wave range.

The wheel center 3 and likewise the wheel rim 2 thus possess in each case a thermo-function structure 7 of substantially identical properties and quality.

The operating state of the vehicle wheel 1 in the braking phase is shown in FIG. 3.

The thermal radiation which by the brake disk 6 is emitted axially in the direction of the vehicle wheel 1 (horizontal arrow in FIG. 3 in the wheel-hub-proximal region of the wheel center 3) is largely transmitted to the thermo-function structure 7 in the hotspot region of the wheel center 3, said thermo-function structure 7 as an almost real radiator absorbing the thermal radiation in a largely complete manner.

The absorbed heat as thermal energy along the thermo-function structure 7 of the wheel center 3 is distributed about the entire circumference of the wheel center 3 (arrows along the internal and the external side of the wheel center 3 in FIG. 3) and can accordingly be emitted over a large area on the surface of the internal and the external side of the wheel center 3 that is less stressed in thermal terms, outside the hotspot region of the wheel center 3.

The thermal energy by way of the connection to the thermo-function structure 7 of the wheel rim 2 can additionally be dissipated in the direction of the rim well and of the rim flanges 8 (horizontal arrow along the rim well of the wheel rim 2 in FIG. 3).

In the stationery phase of the vehicle wheel 1 which is not illustrated, the thermal radiation which is largely absorbed by way of the thermo-function structure 7 of the wheel rim 2 in the hotspot region of the wheel rim 2 (drop center 14) can not only be dissipated and emitted in the direction of the bead seats 15 and the rim flanges 8 but also be transmitted to the connected thermo-function structure 7 of the wheel center 3 and be distributed about the entire circumference of the wheel center 3, where said thermal radiation can be emitted over a large area on the surface of the internal and the external side of the wheel center 3 that is less stressed in thermal terms.

This embodiment offers a maximum potential absorption of the thermal radiation generated in the respective operating states, and furthermore offers a particularly high degree of thermal transmission and maximum potential thermal distribution and emission faces in association with a particularly high degree of thermal emission.

On account thereof, a particularly efficient cooling effect can be achieved for the protection of the support structure 11 of the wheel rim 2 and the wheel disk 3 that is situated therebelow, since the pitch fibers 13, on account of the favorable mechanical properties thereof, in the thermo-function structures 7 can contribute toward the load bearing capability of the support structure 11 of the wheel rim 2 and the wheel disk 3, and consequently the mass required for the functioning of the vehicle wheel 1 can be optimized.

FIG. 3a shows a section illustrated in an enlarged manner through a spoke 4 of the wheel center 3 according to FIG. 3, along the section line B. The support structure 11 of the spoke 4 from carbon-fiber-reinforced plastics material can be seen in detail from this illustration, said support structure 11 having a mold core 18 and a plurality of tiers 12 of the carbon-fiber-reinforced plastics material that encircle the mold core 18 and are connected so as to abut one another and form the fibrous layers 12 of the support structure 11.

The thermo-function structure 7 which in the region of the spoke 4 is formed from two sub-tiers 19, the latter configured in the manner of half-shells and corresponding to preformed fibrous scrim 19, comprising or being formed from pitch-based fibers 13 which in each case comprise the support structure 11 of the spoke 4 on both sides of the spoke 4, is disposed so as to bear on the external circumference of the support structure 11.

The sub-tiers 19 in the manner of half-shells of the thermo-function structure 7 are disposed so as to overlap in the region of the spoke intermediate space 10, on account of which the heat transportation along the thermo-function structure 7 is improved in comparison to a connection of merely abutting preformed sub-tiers in a but joint, the thermal transmission and distribution about the circumference of the spoke 4 (in the direction of the arrows) also becoming more efficient.

Alternatively, the thermo-function structure 7 in the region of the spokes 4 can also be configured by way of pitch-based fibers 13 of a braided fibrous woven fabric, wherein the elastic textile tube to this end is placed onto the prefabricated support structure 11 of the spoke 4 and molded thereto in an enclosing manner (not illustrated).

The technological complexity for the production and the molding of the thermo-function structure 7 can thus be minimized, and the abutting seams, or overlapping seams, respectively, as are created on account of the preformed sub-tiers 19, can in particular be avoided, this even further improving the heat transmission and distribution about the circumference of the spoke 4.

FIG. 4 shows a sectional view of a vehicle wheel 1 having features similar to the vehicle wheel 1 according to FIGS. 1, 1b, and in the operating state of the braking phase corresponding to the operating state according to FIG. 2.

In order for repetitions to be avoided, only the points of differentiation in terms of the features and the effective modes in comparison to the embodiment of the vehicle wheel 1 according to FIGS. 1, 1b and the operating state according to FIG. 2 will be described hereunder.

The wheel rim 2 and the wheel center 3 in the case of this exemplary embodiment are in each case composed of glass-fiber-reinforced plastics material. The support structures 11 of the wheel rim 2 and of the wheel center 3 have in each case a plurality of tiers 12 of the glass-fiber-reinforced plastics material. This fiber-composite material is indeed somewhat softer in comparison to the fiber-composite material of the support structures 11 of the vehicle wheel 1 according to FIGS. 1, 1b, but is more tolerant in relation to damage in terms of thermal influences.

The wheel center 3 and the wheel rim 2 have in each case a thermo-function structure 7 from a fibrous layer comprising or being from pitch-based carbon fibers 13.

The thermo-function structures 7 are thus thermally highly conductive as well as, as a real blackbody, particularly well radiation-absorbing and radiation-emitting in the infrared wave range.

The highly conductive and infrared radiation-absorbing and infrared radiation-emitting thermo-function structure 7 of the wheel rim 2 extends across the entire rim internal side to the rim flanges 8. The thermo-function structure 7 of the wheel center 3 extends across the wheel center internal side so as to include the wheel flange 9 and can additionally protrude to or into the spoke intermediate spaces 10, or fill the latter.

The highly conductive and infrared radiation-absorbing and infrared radiation-emitting thermo-function structures 7 of the wheel center 3, and the thermo-function structure 7 of the wheel rim 2, are connected to one another in the transition region from the wheel center 3 to the wheel rim 2, corresponding to the exemplary embodiment according to FIG. 1b.

The thermo-function structures 7 of the wheel disk 3 and of the wheel rim 2 have in each case an infrared radiation-permeable cover layer 20. Said cover layer 20 is preferably a transparent or slightly dyed PE film, or an infrared radiation-permeable lacquer, for example an acrylic-base lacquer.

Said cover layer 20 predominantly serves as the mechanical protection of the pitch fibers 13 of the covered region of the thermo-function structure 7, or else for the aesthetic design of the visible surface of the thermo-function structure 7, without significantly impeding the passage of the thermal radiation and weakening the absorption output or emission output, respectively, of the covered thermo-function structure 7.

Since the infrared radiation-permeable cover layer 20 in terms of thermal technology barely has any influence on the function of the thermo-function structure 7, the procedures and effective modes of the shown operating state of the vehicle wheel 1 in terms of thermal technology correspond in principle to the respective preceding descriptions pertaining to the operating state “braking phase” in the preceding exemplary embodiments according to the vehicle wheel according to FIGS. 1b, 2, and 3.

For design purposes, it is conceivable for the cover layer 20 in part, or in portions, respectively, to be designed so as to be dyed in an opaque manner, without disadvantageously compromising the required throughput performance for transmitting the thermal radiation.

The cover layer 20, for example in the region of the direct radiation input to the thermo-function structure 7 of the wheel rim, or of the wheel center, respectively, such as, for example, in the region of the rim well/drop center and of the wheel-hub-proximal region of the wheel center internal side (thermal input regions) and/or in particularly radiation-effective thermal output regions (rim flange, spoke external side) can thus be configured in the aforedescribed manner so as to be infrared radiation-permeable, transparent, and in regions of a predominant heat transmission function of the thermo-function structure 7 of the wheel rim, or of the wheel center, respectively, (such as, for example, at the spoke intermediate spaces, at the wheel flange, at the transition from the drop center to the bead seat) can be configured so as to be dyed opaque (not illustrated).

The cover layer 20 configured so as to be infrared radiation-permeable, transparent, can furthermore be varied in arbitrary patterns, having a cover layer that is configured so as to be dyed opaque.

The transitions between the cover layer 20 configured so as to be infrared radiation permeable, transparent, and a cover layer configured so as to be dyed opaque can moreover be designed so as to be fluent.

### LIST OF REFERENCE SIGNS

1 Vehicle wheel
2 Wheel rim
3 Wheel disk, wheel center
4 Spoke of the wheel center
5 Wheel hub
6 Brake system having brake disk
7 Thermo-function structure
8 Rim flange
9 Wheel flange of the wheel disk, or the wheel center
10 Spoke intermediate space
11 Support structure
12 Tier, fibrous layer of the support structure
13 Pitch-based carbon fibers, pitch fibers
14 Drop center of the wheel rim
15 Bead seat
16 Fibrous woven fabric, textile tube
17 Threads, fibers, running in the circumferential direction
18 Mold core
19 Fibrous scrim, sub-tiers
20 Infrared-radiation-permeable cover layer

1.-13. (canceled)

14. A vehicle wheel that is connectable to a brake system, the vehicle wheel comprising:
a wheel rim; and
a wheel disk, wherein at least one of the wheel rim or the wheel disk includes a support structure comprised of fiber-reinforced plastic, wherein on a side of the support structure that faces the brake system at least one of the wheel rim or the wheel disk includes a thermo-function structure that in thermal terms is configured so as to be more conductive than the support structure, wherein the thermo-function structure extends such that thermal energy generated by the brake system is discharged from a first region of at least one of the wheel rim or the wheel disk that is stressed in thermal terms due to the thermal energy into a second region of at least one of the wheel rim or the wheel disk that is less stressed in thermal terms.

15. The vehicle wheel of claim 14 wherein the thermo-function structure is configured to be highly thermally conductive.

16. The vehicle wheel of claim 14 wherein the thermo-function structure contains carbon fibers.

17. The vehicle wheel of claim 14 wherein the thermo-function structure is configured to be radiation-absorbing and radiation-emitting in an infrared wave range.

18. The vehicle wheel of claim 17 wherein the thermo-function structure is configured as a real blackbody.

19. The vehicle wheel of claim 14 wherein the thermo-function structure contains pitch-based carbon fibers.

20. The vehicle wheel of claim 14 wherein the thermo-function structure is comprised of a fibrous woven fabric, a fibrous knitted fabric, or a fibrous scrim.

21. The vehicle wheel of claim 20 wherein the fibrous woven fabric is elastic.

22. The vehicle wheel of claim 20 wherein the fibrous scrim is elastic.

23. The vehicle wheel of claim 14 wherein the thermo-function structure is a first thermo-function structure of the wheel rim, the vehicle wheel comprising a second thermo-function structure of the wheel disk, wherein the first and second thermo-function structures are connected.

24. The vehicle wheel of claim 23 wherein the first and second thermo-function structures have a cover layer, at least in part.

25. The vehicle wheel of claim 24 wherein the cover layer is configured to be infrared-radiation-permeable.

26. The vehicle wheel of claim 14 wherein the thermo-function structure extends to or into a side of the wheel disk and/or the wheel rim that faces away from the brake system.

27. The vehicle wheel of claim 14 wherein the thermo-function structure is connected to a thermally conducting component of the vehicle wheel.

28. The vehicle wheel of claim 14 wherein the thermo-function structure has a cover layer, at least in part.

29. The vehicle wheel of claim 28 wherein the cover layer is configured to be infrared-radiation-permeable.

30. The vehicle wheel of claim 14 wherein the thermo-function structure extends such that thermal energy generated by the brake system is substantially discharged from the first region into the second region.
